(19) United States
(12) Patent Application Publication
(10) Pub. No.: US 2007/0171666 A1
(43) Pub. Date: Jul. 26, 2007

(54) VEHICLE HEADLAMP

(75) Inventors: Josephus Christiaan Maria HENDRICX, Eindhoven (NL); Theodorus Petrus Cornelis Maria VOS, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,715

(22) PCT Filed: Jan. 25, 2005
(86) PCT No.: PCT/IB05/50291

§ 371 Date: Aug. 4, 2006

(30) Foreign Application Priority Data
Feb. 10, 2004 (EP) 04100492.0

(51) Int. Cl. B60Q 1/00

(52) U.S. Cl. 362/538

(57) ABSTRACT

Vehicle headlamp provided with a metal halide lamp comprising a discharge vessel surrounded by an outer envelope with clearance and having a ceramic or quartz wall which encloses a discharge space containing Xenon (Xe) and a filling of ionizable particles, wherein in said discharge space two electrodes are arranged whose tips have a mutual interspacing so as to define a discharge path between them, with the special feature that said headlamp comprises means to vary the spatial distribution of the ionizable particles inside the discharge vessel, such that said spatial distribution changes along the axis of the metal halide lamp in the horizontal orientation of the metal halide lamp.

The present invention relates to a vehicle headlamp provided with a metal halide lamp comprising a discharge vessel surrounded by an outer envelope with clearance and having a wall which encloses a discharge space containing Xenon (Xe) and a filling of ionizable particles, wherein in said discharge space two electrodes are arranged whose tips have a mutual interspacing so as to define a discharge path between them. Said wall may be made of, for example, a ceramic or quartz material. The invention also refers to a metal halide lamp to be used in the present headlamp.

Such a lamp is known from international (PCT-) patent publication no. WO 00/67294, in the name of the same Applicant. This known electric discharge lamp has a tubular, light-transmissive ceramic lamp vessel, for example of polycrystalline aluminum oxide, and a first and a second current conductor which enter the lamp vessel from opposite ends and each support an electrode in the lamp vessel, for example a tungsten electrode, which is welded to the current conductors. The second current conductor has a return portion extending along an outside of the outer envelope made of quartz. A ceramic sealing compound provided in a melting process seals the lamp around the current conductors in a gastight manner. The lamp vessel has an ionizable filling comprising xenon as a rare gas and metal halides. Specific dimensions of the discharge vessel of the known lamp ensure a very compact and light weight lamp.

A disadvantage of a vehicle headlamp described in the above PCT-patent publication is that it does not satisfy the need felt by drivers of automobiles to be able to vary lamp characteristics, such as the light intensity and the light colour.

It is an object of the invention to enable influencing the light-generating properties of a metal halide lamp in a vehicle headlamp in the horizontal orientation, particularly its light intensity and its light colour.

In order to accomplish that objective, a vehicle headlamp of the type mentioned in the opening paragraph is characterized in accordance with the invention in that said vehicle headlamp comprises means to vary the spatial distribution of the ionizable particles inside the discharge vessel, such that said spatial distribution changes along the axis of the metal halide lamp in the horizontal orientation of the metal halide lamp. This phenomenon (the spatial distribution being dependent on the location along said axis) is called segregation. Since, in a metal halide lamp, light is produced by the ionizable particles, segregation has the consequence that the light intensity and the light colour are not constant anymore along the central axis of the lamp. As legal regulations require minimum luminance levels at certain fixed points in a beam pattern generated by a vehicle headlamp, any variation in light intensity along the central axis of the lamp due to segregation must not lead to an undershooting of said minimum luminance levels. On the other hand, legally required maximum luminance levels at fixed points or areas in the flare area may not be overshot.

In one embodiment of a vehicle headlamp according to the invention, said vehicle headlamp comprises current-generating means for generating an average direct current inside the discharge vessel in a direction such that a transport of ionized particles is obtained in the direction of one of the electrodes nearest to the focal point of a reflector present in the headlamp. The direction of the average direct current is therefor opposite to the particle transport direction. The present invention is based, inter alia, on the insight that the direct current through the metal halide lamp influences the distribution of ionized particles in the discharge vessel. More in particular, the average direct current induces a shift of ionized particles in the direction of the so-called “socket electrode”, that is the electrode nearest to the focal point of the reflector. The concentration of ionized particles close to said socket electrode is thus increased, resulting in a gradient of ionized particles within the discharge vessel. The illuminances at fixed points in the beam pattern of the present vehicle headlamp, as discussed earlier, are mainly generated by means of the projection of parts in an arc in the discharge path, said parts lying close to the focal point of the reflector. In order to maintain the light intensity in these parts as high as possible, the ionized particles are thus drawn to the socket electrode. In other words, addition of a direct current component to the alternating operating current of the vehicle headlamp induces segregation in the discharge vessel, so that the intensity and the colour of the discharge arc change at several locations along the central axis of the lamp, both locally and averagely. If it were desirable to create only a colour change, for example a different colour in the center of the beam pattern than elsewhere in the beam pattern, then the luminance in a part of the arc that is close to the “socket electrode” should be kept constant by power control. Of course, at a certain point in time an equilibrium state will develop in the sense that a cloud of ionized particles will have formed near the socket electrode, effectively shielding the negative charge of said socket electrode, thereby reducing the electrical field induced by said average direct current.

In a further embodiment of a vehicle headlamp in accordance with the invention, said vehicle lamp comprises a ballast for controlling the operating power of the lamp in dependency on the strength of the average direct current, such as to obtain a predetermined maximum luminance level near one of the electrodes nearest to the focal point of the reflector. As mentioned above, due to the average direct current, not only the colour but also the light intensity will vary along the arc in the discharge path. In order to ensure that the light intensity at the parts lying close to the focal point of the reflector is kept constant in time and does not exceed a predetermined maximum luminance level, the operating power of the lamp and the average direct current are mutually adjusted. It is noted that exceeding said predetermined maximum luminance level would give rise to glare of oncoming traffic leading to dangerous, i.e. life threatening traffic situations.

In a further embodiment of a vehicle headlamp according to the invention, the discharge vessel is mirror symmetrical in shape, seen in cross-section. In an alternative embodiment, the discharge vessel may be asymmetrical in shape, seen in cross-section. Particularly, a first end part of the discharge vessel near one of the electrodes nearest to the focal point of the reflector differs in geometry, diameter, length, circumference, cross-sectional area, surface, volume and/or type of material from a second end part of the discharge vessel near the other electrode. Preferably, the distance from an electrode tip, that is nearest to the focal point of the reflector, to a bottom of the discharge vessel closest to this electrode tip is larger than the distance from a tip of the other electrode to a bottom of the discharge vessel closest to the latter electrode tip. In the case of symmetric lamps, liquid salts located behind the electrodes will vaporize and be transported to the socket electrode due to the average direct current only after a certain period of time. This gives rise to an additional change in light color. This can be avoided by changing the duty cycle of the average direct current with the help of the ballast such that the additional color change is compensated for. In the case of asymmetric lamps, such an additional change in light color does not occur, as a temperature rise at an end part near the electrode opposite the electrode nearest to the focal point of the reflector will cause no coldest spot in the end.

In a further embodiment of a vehicle headlamp in accordance with the invention, the current-generating means do not generate the average direct current during running up of said metal halide lamp. The normal strength of the average direct current might cause overheating of the electrodes during running up leading to evaporation of tungsten and thus to blackening of the ceramic wall of the discharge vessel. In the alternative embodiment, the current-generating means generate a lower average direct current during running up of said metal halide lamp than during normal operation of said metal halide lamp, such that a predetermined maximum temperature of the electrodes during running up of said metal halide lamp is not exceeded. This means, for example, that the ballast present in the lamp allows the average direct current to start flowing only after a predetermined operating power of the lamp has been reached.

The invention also relates to a metal halide lamp to be used in a vehicle headlamp according to the invention.

The invention will be explained in more detail with reference to the Figures, wherein:

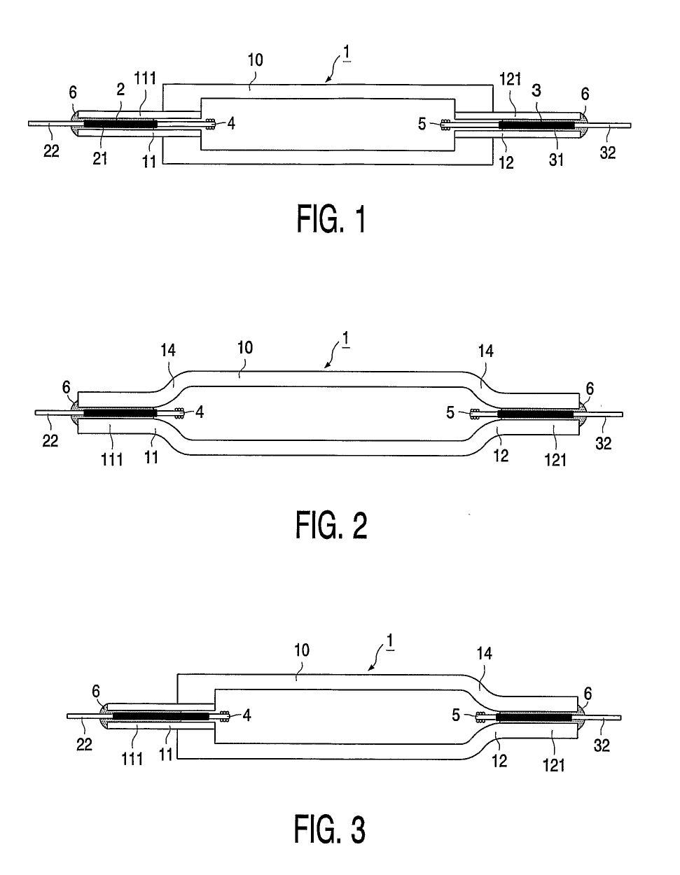

FIG. 1 shows a cross-section of a first embodiment of a vehicle headlamp;

FIG. 2 shows a cross-section of a second embodiment of a vehicle headlamp; and

FIG. 3 shows a cross-section of a third embodiment of a vehicle headlamp.

In FIG. 1, the electric discharge vehicle headlamp has a tubular, light-transmissive ceramic lamp vessel 1, of polycrystalline aluminum oxide, and first and second current conductors 2,3, which enter the lamp vessel 1 at opposite ends thereof, each support a tungsten electrode 4,5 in the lamp vessel 1, which electrode is welded to the current conductors 2,3. A ceramic sealing compound 6, containing 30% by weight of aluminum oxide, 40% by weight of silicon oxide and 30% by weight of dysprosium oxide, provided in a melting process seals the lamp vessel 1 around the current conductors 2,3 in a gastight manner. As an alternative, the lamp vessel 1 could be made from quartz.

The lamp vessel has an ionizable filling comprising a rare gas, such as xenon and/or argon, and a metal halide, being for instance a mixture of sodium iodide and cerium iodide. Also bromides or other halides are possible however.

In a practical example, where the overall pressure inside the vessel 1 is of the order of 10-25 atm during operation, the vessel 1 may contain mercury and a relatively small amount of argon.

The metal halides are provided as a saturated system comprising an excess amount of salt, such that during operation of the lamp a pool of molten salt will be present inside the lamp vessel 1.

The current conductors 2,3 have first halide-resistant parts 21,31 extending within the lamp vessel 1 and second parts 22,32 extending from the cerarmic sealing compound 6 to the exterior of the lamp vessel, said second parts being 22,32 connected to the first parts 21,31 by welding.

The first parts 21,31 of the first and second current conductors 2,3 are made from molybdenum aluminide or a mixture of Mo and Al₂O₃. The second parts 22,32 of each of the two current conductors 2,3 consist of niobium.

The lamp vessel 1 has narrow end parts 11,12 in which the respective current conductors 2,3 are enclosed. The end parts 11,12 have a free end 111, 121, where the lamp vessel 1 is sealed by the ceramic sealing compound 6.

The lamp vessel 1 is enveloped by an outer envelope (not shown) which is sealed in a gastight manner and evacuated or filled with an inert gas in order to protect the niobium second parts 22,32 of the current conductors 2,3.

In operation, a discharge will extend between the electrodes 4,5. Due to the high temperature of the discharge, the halides will be ionized and produce light. The colour and the colour-temperature of the discharge are different for different substances. For instance, the light produced by sodium iodide is red while light produced by cerium iodide is green. Typically, the lamp will contain a mixture of suitable substances, and the composition of this mixture, i.e. the identity of said substances as well as their mutual ratio, will be chosen such as to obtain a specific overall colour. In a typical example the molar ratio between sodium iodide and cerium iodide is 5:1.

Furthermore, by applying a direct current component through the lamp, the ionized halide mixture can to a certain extent be forced to one side of the lamp vessel 1, and, in addition, the different halides are segregated to a certain extent, thereby obtaining a local and an overall, different, colour temperature of the lamp. In this way, by using a suited lamp driver, a continuous variable colour temperature control of the lamp can be obtained. In order to be able to have stable control of the colour temperature of the lamp, it would however be preferred that the excess of said halides always precipitates on one side of the lamp vessel 1, namely at the location of the socket electrode, i.e. the electrode nearest to the focal point of a reflector present in the lamp.

According to FIG. 1, the lamp vessel 1 is comprised of a central cylindrical part 10 which is connected by way of sintering to the narrowed cylindrical end parts 11,12.

According to FIG. 2, the lamp vessel is comprised of a central cylindrical portion 10 and two tapered end portions 14 forming the connection with the narrowed cylindrical end portions 11,12. The thickness of the wall of the central cylindrical portion 10, the tapered end portions 14 and the narrowed end portions 11,12 is substantially equal. Both end portions typically are bottleneck shaped. In comparison with the end portions shown in FIG. 1, more heat can be applied to the end portions of the vessel 1 without the risk of cracking of said end portions, so that the molten sealing material 6 can penetrate deeper into the narrowed cylindrical end portions 11,12, thereby leaving a smaller gap behind the electrodes 4,5. In a saturated metal halide lamp, such a gap, acting as a cold spot, is a typical place for salt to precipitate during operation. As this type of lamp is symmetrical, it will however have the same disadvantages as the lamp type of FIG. 1 in a continuous variable colour temperature driver.

According to FIG. 3, the lamp vessel is comprised of a central cylindrical portion 10 which, at a first end, is connected by way of sintering to the narrowed cylindrical end part 11. At the second end, the vessel comprises a tapered end portion 14 forming the connection with the narrowed cylindrical end portion 12. The thickness of the wall of the central cylindrical portion 10, the tapered end portion 14 and the narrowed end portion 12 is substantially equal. The second end portion is typically bottleneck-shaped.

In the configuration of FIG. 3, the second end portion of the lamp vessel 1 near the second electrode 5 will have a higher temperature during operation than the first end portion near the first electrode 4, which is caused by the greater mass present near the first electrode, resulting in a better heat radiation capacity of the first end portion.

1. Vehicle headlamp provided with a metal halide lamp comprising a discharge vessel surrounded by an outer envelope with clearance and having a wall which encloses a discharge space containing Xenon (Xe) and a filling of ionizable particles, wherein in said discharge space two electrodes are arranged whose tips have a mutual interspacing so as to define a discharge path between them, characterized in that said vehicle headlamp comprises means to vary the spatial distribution of the ionizable particles inside the discharge vessel, such that said spatial distribution changes along the axis of the metal halide lamp in the horizontal orientation of the metal halide lamp.

2. Vehicle headlamp according to claim 1, wherein said vehicle headlamp comprises current-generating means for generating an average direct current inside the discharge vessel in a direction such that a transport of ionized particles is obtained in the direction of one of the electrodes nearest to the focal point of a reflector present in the headlamp.

3. Vehicle headlamp according to claim 2, wherein said vehicle headlamp comprises a ballast for controlling the operating power of the lamp in dependency on the strength of the average direct current, such as to obtain a predetermined maximum luminance level near one of the electrodes nearest to the focal point of the reflector.

4. Vehicle headlamp according to claim 2, wherein the discharge vessel is mirror symmetrical in shape, seen in cross-section.

5. Vehicle headlamp according to claim 1, wherein the discharge vessel is asymmetrical in shape, seen in cross-section.

6. Vehicle headlamp according to claim 5, wherein a first end part of the discharge vessel near one of the electrodes nearest to the focal point of the reflector differs in geometry, diameter, length, circumference, cross-sectional area, surface, volume and/or type of material from a second end part of the discharge vessel near the other electrode.

7. Vehicle headlamp according to claim 6, wherein the distance from an electrode tip, that is nearest to the focal point of the reflector, to a bottom of the discharge vessel nearest to this electrode tip is larger than the distance from a tip of the other electrode to a bottom of the discharge vessel nearest to the latter electrode tip.

8. Vehicle headlamp according to claim 1, wherein the current-generating means do not generate the average direct current during running up of said metal halide lamp.

9. Vehicle headlamp according to claim 1, wherein the current-generating means generate a lower average direct current during running up of said metal halide lamp than during normal operation of said metal halide lamp, such that a predetermined maximum temperature of the electrodes during running up of said metal halide lamp is not exceeded.

10. Metal halide lamp to be used in a vehicle headlamp according to claim 1.
